(19) United States
(12) Patent Application Publication
(10) Pub. No.: US 2016/0044903 A1
(43) Pub. Date: Feb. 18, 2016

(54) FISHING ROD HANDLE WITH FREE-FLOATING ROD BLANK

(71) Applicant: Nathaniel Paul GRAHL, Cape Coral, FL (US)

(72) Inventor: Nathaniel Paul GRAHL, Cape Coral, FL (US)

(21) Appl. No.: 14/459,862

(22) Filed: Aug. 14, 2014

(51) Int. Cl. A01K 87/08; A01K 87/02; A01K 87/06

(52) U.S. Cl. CPC A01K 87/08; A01K 87/06; A01K 87/02

(57) ABSTRACT

A fishing rod assembly is provided that includes a rod blank and a handle affixed to a proximal end of the rod blank. The handle has a base part and a reel seat part adjacent and distal to the base part for accommodating a reel. The rod blank is supported only at its rearmost end by the base part of the handle so that the rod blank is free to move in response to even small forces applied to a tip of the rod. In addition, the rod blank is exposed up to a forward face of the handle base part, enabling the fisherperson to hold the handle while easily maintaining direct tactile contact with the rod for better detection of rod blank movement and improved fishing rod sensitivity.

### BACKGROUND OF THE INVENTION

1. Field of Invention

This invention relates generally to fishing apparatus and, more particularly, to a fishing rod which provides improved sensitivity to the person fishing when experiencing the pull on a fishing line.

2. Description of the Related Art

It is well known that success at catching fish often hinges on the ability to react quickly when a fish strikes. One's reaction time is determined, in part, on the ability to sense, through the handle of a rod, the forces exerted on the tip of the rod by a fish's strike. A rod's ability to communicate these forces to the hands of a fisherperson is generally referred to as the rod's sensitivity. Typically, the more sensitive the rod, the faster one may react to a strike.

The sensitivity of a rod is diminished, however, when forces other than those caused by the strike of a fish are communicated by the rod. Such forces include, for example, those caused by the weight of the rod as well as the weight of the reel. In the case of rods, light-weight material, such as graphite, is often used to increase their sensitivity by decreasing their weight. However, the weight of the reel may yet adversely affect the rod when the rod and the reel are both supported on the reel mount and handle of the rod assembly.

Additionally, traditional construction of a rod includes a separate rod blank inserted into a rod handle that is coupled to a reel mount. The purpose of the rod blank is to transmit the activity of the fish to the fisherperson. The purpose of the rod handle and reel mount is to give the fisherperson a secure way to grasp onto the rod and to securely attach the reel. Because the reel mount and handle are constructed of much sturdier material than the rod, direct contact between the rod and the reel mount/handle assembly inhibits movement of the rod blank and hinders the ability of the rod blank to transmit small movements of the rod tip, indicative of fish activity, to the hand of the fisherperson.

Therefore, it would be desirable to secure the reel to the reel mount and the handle while keeping the rod blank unencumbered by the weight of the reel to allow the rod blank to move more freely in response to forces exerted on the tip of the rod. Even greater benefit from the increased freedom in rod blank movement could be obtained if the fisherperson were provided with a better ability to feel rod blank movement.

### SUMMARY OF THE INVENTION

In view of the foregoing, the present invention is directed to a fishing rod assembly including an elongated rod blank and a handle. The handle includes a base part and a reel seat part adjacent and distal to the base part for mounting a reel. The reel seat part is supported by the base part of the handle but is not in direct contact with the rod blank. The rod blank is supported only at its proximal or rearmost end by the base part of the handle so that the remainder of the rod blank is free-floating and can move in response to even small forces applied to the tip thereof by a fish through the fishing line. In addition, the rod blank is exposed from the tip to a forward face of the base part of the handle to enable the fisherperson's hand to both hold the rod handle and be in direct tactile contact with the rod blank while fishing.

Accordingly, it is an object of the present invention to provide a rod design which enhances the effectiveness of a fisherperson.

Another object of the present invention is to provide a rod having improved sensitivity to line action, enabling the fisherperson to better detect fish nibbles or strikes.

A further object of the present invention is to provide a rod construction including a rod blank and a handle in which the rod blank is supported by a base part of the handle and at no other point along the rod blank's length, a remainder of the rod blank being free-floating to allow the rod blank to move in response to even small forces applied to the tip thereof.

Yet another object of the present invention is to provide a rod construction in accordance with the preceding object in which the rod blank is exposed all the way from the tip to the forward face of the handle base part, enabling the fisherperson's hand, while on the handle where the rod is typically held, to also be in direct contact with the free-floating rod blank to detect actual movement thereof and not just vibrations which might otherwise go completely undetected.

A further object of the present invention is to provide a rod construction in accordance with the preceding objects in which the proximal end of the rod blank is secured within an insert and in which the base part has a central bore that receives the insert with the rod blank secured therein, an outer surface of the base part being threaded for removable attachment of a handle grip.

A still further object of the present invention is to provide a rod construction in accordance with the preceding objects in which the handle includes a reel seat part integral with and extending distally from the base part, the reel seat part having a concave upper surface that is generally parallel with and spaced from the rod blank so as not to be in contact with the rod blank, the bottom side of the reel seat part having a flat reel seat surface and a fixed hood with a recess for receiving the distal leg of a reel.

Another object of the present invention is to provide a reel seat part in accordance with the preceding object in which the weight of a mounted reel is supported by the reel seat part of the handle while the rod blank is supported by the base part of the handle so that the rod blank remains unencumbered by the weight of the reel.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1A is a perspective view of a handle supporting a rod blank in accordance with the present invention.

FIG. 1B is a cross sectional view taken along line A-A of FIG. 1A.

FIG. 2 is a side view of the handle and rod blank shown in FIG. 1.

FIG. 3 is a side view of a fishing rod assembly including the handle and rod blank shown in FIG. 1.

FIG. 4A is a cross sectional view taken along line A-A of FIG. 2.

FIG. 4B is a cross sectional view taken along line B-B of FIG. 2.

FIG. 5 is a top view of the handle and rod blank shown in FIGS. 1-3.

FIG. 6 is a bottom view of the handle and rod blank shown in FIGS. 1-3.

### DETAILED DESCRIPTION OF THE PREFERRED EMBODIMENTS

Although only one preferred embodiment of the invention is explained in detail, it is to be understood that the embodiment is given by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

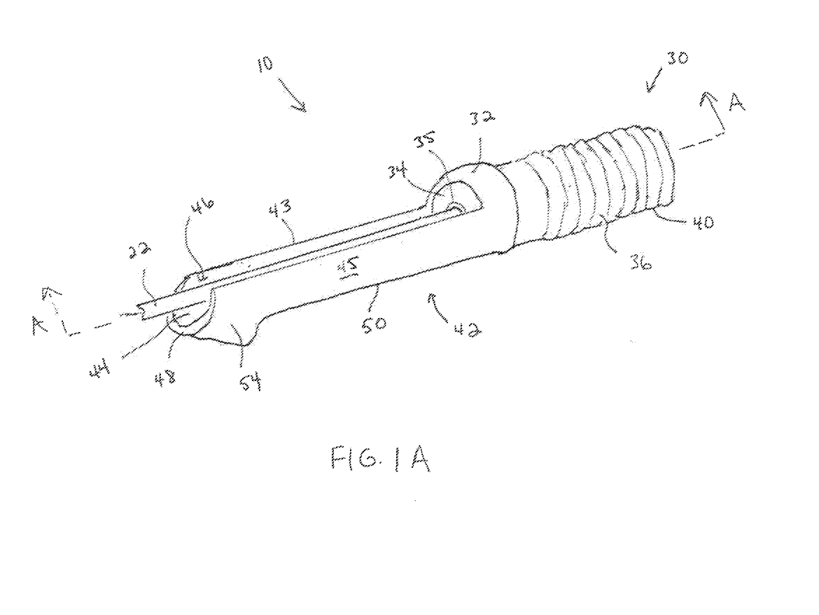

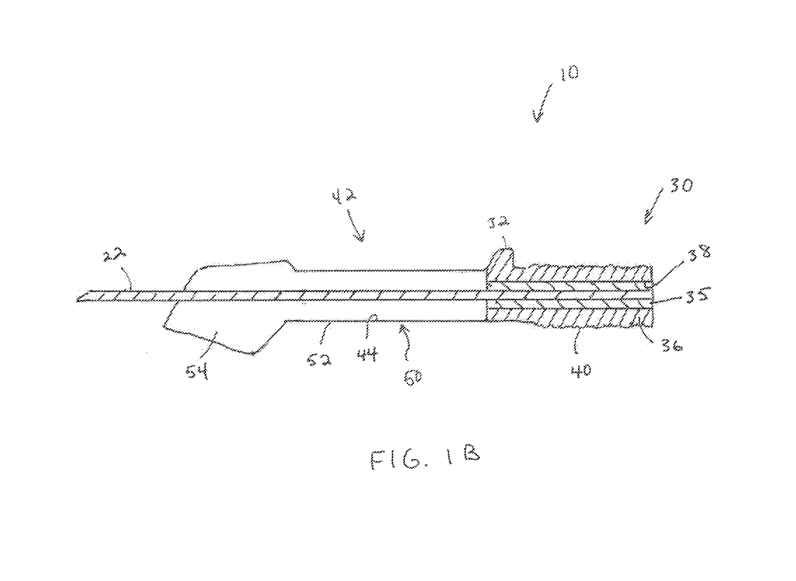

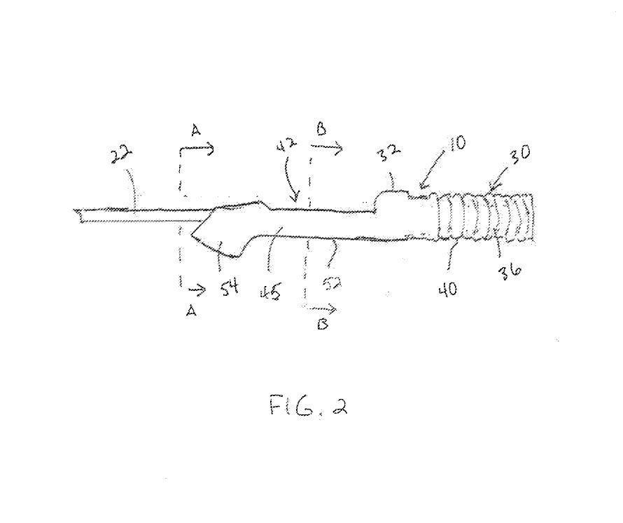

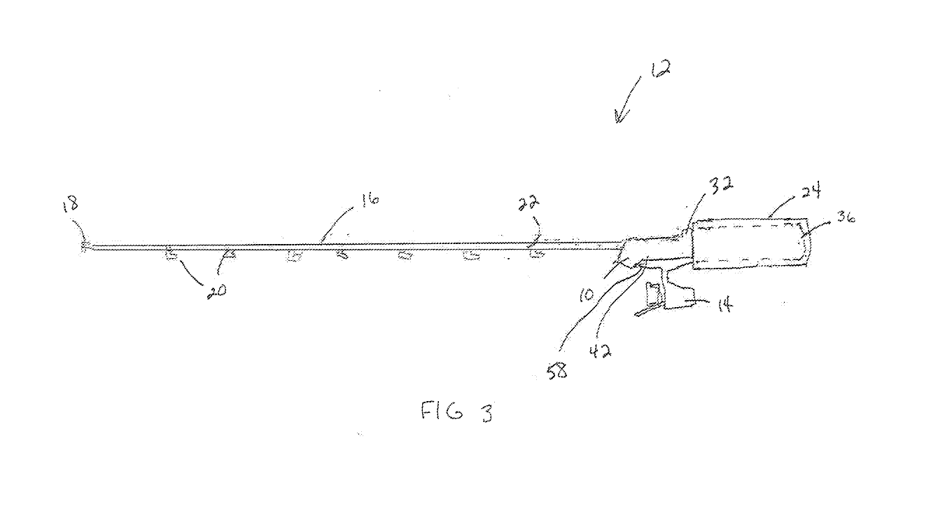

As shown in FIGS. 1A, 18 and 2, the present invention is directed to a handle, generally designated by reference numeral 10, for a fishing rod assembly generally designated by reference numeral 12, as representatively shown in FIG. 3. The fishing rod assembly 12 generally includes the handle 10 with a grip 24, a reel 14, and an elongated rod blank 16 with a tip 18 and a plurality of line guides 20. The rod blank may be made of a lightweight material such as graphite or plexiglass, and either be unitary, as shown, or include two or more rod blank sections that may be arranged to form a single shaft, as is common in the art.

As used herein, “proximal” and “rear” refers to that end of the structure nearest the fisherperson, while “distal” and “forward” refers to the opposite end, i.e., that end of the structure that is nearest to the tip of the rod. The terms “lower” and “bottom” refer to the rod assembly side against which the reel is mounted, while the terms “upper” and “top” refer to that side of the rod assembly opposite the reel.

Also as used herein, “rod” and “rod blank” are used interchangeably to refer to the pole portion of a fishing rod assembly.

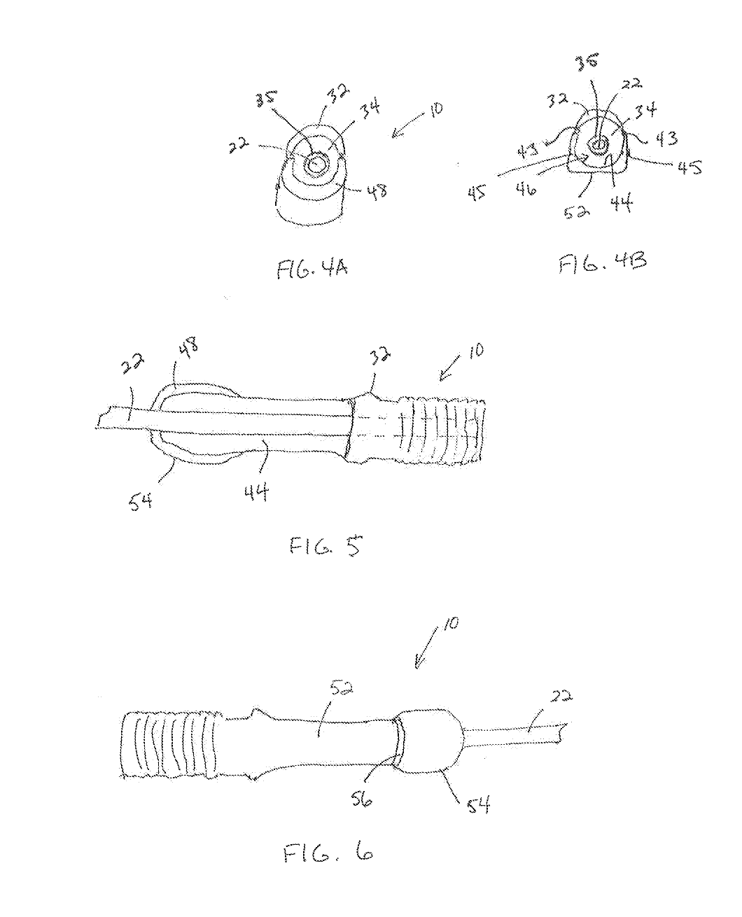

The handle includes a base part 30 and a reel seat part 42 distal to the base part. The base part has an arched distal end 32 having an inset forward face 34 (see FIGS. 4A and 4B) and a generally cylindrical base body 36 proximal to the distal end 32. The base body 36 preferably has a threaded outer surface 40 for insertion in and attachment to the internally threaded rod grip 24 at the proximal end of the fishing rod assembly 12, as shown by dashed lines in FIG. 3. A central bore 38 extends proximally from the forward face 34 into the body 36. The proximal end of the rod blank 22 is received and secured within the bore 38 so that the rod blank 22 is mounted concentrically to the base part 30 of the handle with no other support along its length. Limiting rod blank support to only that provided by the base part 30 allows the rod blank to be free-floating and to move without restriction until the blank bends so much that it comes into contact with the reel seat assembly below it as will be discussed further hereinafter.

According to the illustrated embodiment, the proximal end of the rod blank is received within a generally cylindrical insert 35 that is bored out to the diameter of the rod blank proximal end. The rod blank proximal end is preferably permanently adhered to the inside diameter of the insert using an adhesive such as glue. The outer diameter of the insert is substantially the same as the inside diameter of the central bore 38, allowing the insert to be tightly secured within the central bore. The insert is also preferably permanently adhered to the inside diameter of the base part bore using an adhesive such as glue. Use of the insert facilitates manufacture, particularly with small diameter rod blanks, by ensuring a close fit and axial alignment of the blank with the base part. The insert also provides a simplified means of accommodating different blank diameters without the need to change the central bore diameter in the handle base. Rather, the same size central bore may be used for a range of rod blank diameters by drilling out a smaller or a larger bore through the insert while the outer diameter of the insert and the inner diameter of the central bore can remain constant.

The reel seat part 42 is integral with and extends distally from the arched distal end 32 of the base body 36. The distal end of the reel seat part 42 is flared with a sloping forward face 48 (see FIGS. 1, 4A and 5). The bottom side 50 of the reel seat part includes a flat reel seat surface 52 (see FIGS. 4B and 6) and a fixed hood 54 located distal to the reel seat surface 52. The fixed hood 54 has a rearwardly facing recess 56 for receiving the distal leg 58 of the reel 14 (see FIG. 3) in a manner known to those skilled in the art.

As shown in FIG. 4B, the top side 44 of the reel seat part 42 is concave, preferably semi-cylindrical, and has upwardly curved sides 45 that create a trough generally designated by reference numeral 46 through which the rod blank extends. The rod blank 22 is spaced from the upper surface 44 and from the sides 45 of the trough 46 so that the rod blank is not in direct contact with the reel seat part. The distance between the lower surface of the rod blank and the upper surface 44 of the trough 46, as well as the distance between the upper edges 43 of the sides 45 and the respectively adjacent sides of the rod blank, may vary provided the spacing ensures that the outer surface of the rod blank is not in contact with the reel seat part of the handle and allows sufficient movement of the rod blank to indicate a fish strike or nibble to the fisherperson. In general, in the case of a semi-cylindrical upper surface 44, the radius of said upper surface 44 should be at least about 1.5 times the radius of the rod blank, and preferably 2-5 times the radius of the rod blank.

According to the illustrated embodiment, the upwardly directed sides 45 provide strength to the reel seat part while leaving a gap between their upper edges that is sufficiently wide to enable the fisherperson to maintain tactile contact with the rod blank in the area bounded by the sides and adjacent the handle base part. Therefore, when fishing, the front portion of the hand, the thumb and/or the forefingers may be in contact with the blank, allowing the fisherperson to feel the movement of the blank directly and obtain better control over the fishing experience. And because the rod blank is free-floating, having only its proximal end supported by the base part of the handle and being nowhere else supported along its length, the rod blank is not impeded from moving in response to even very small forces applied to the tip of the rod blank which are indicative of a fish bite or nibble. As additional forces are applied, the rod blank is able to move freely until it bends so much that it comes into contact with the reel seat part of the handle.

The rod according to the present invention may also be used in a bait casting configuration in which the rod is held 180 degrees out, with the reel seat surface facing upward so that the reel is effectively mounted above the rod blank when the rod is in use. In this configuration, the trough, now upside-down, may touch the adjacent upper side of the rod blank without hindering rod sensitivity since, when bait casting, the force applied to the rod tip by a fish is downward in direction, pulling the blank away from the trough of the reel seat part. In use of the rod in both orientations, however, the rod blank is only supported at its rearmost end by the handle base part and the reel seat assembly and handle do not restrict or burden rod blank movement when fishing.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A fishing rod assembly comprising:
an elongated rod blank having a proximal end and a distal tip;
a handle coupled to said rod blank proximal end, said handle including a base part and a reel seat part positioned distal to said base part, said reel seat part extending forwardly from the base part and including a flat reel seat surface against which a reel is mounted;
a reel wound with fishing line mounted against the reel seat surface of the handle; and
a rearmost end of the rod blank being mounted in a longitudinally extending bore in the base part, said rod blank being supported only at said rearmost end by said base part to be free-floating and more sensitive to forces applied to a tip of the rod blank via the fishing line.

2. The fishing rod assembly as set forth in claim 1, wherein said reel seat part has a top side with a concave upper surface forming a trough, said rod blank extending through said trough and being spaced from said upper surface of the reel seat part so that said rod blank is not encumbered by a weight of a reel mounted against the reel seat surface, said reel seat surface being on the bottom side of the reel seat part.

3. The fishing rod assembly as set forth in claim 2, wherein a curvature of said concave upper surface is generally semi-circular.

4. The fishing rod assembly as set forth in claim 3, wherein a radius of said trough is at least about 1.5 times a radius of said rod blank.

5. The fishing rod assembly as set forth in claim 1, wherein said rod blank is exposed from the tip to a forward face of the handle base part to allow a fisherperson's hand to be on the handle and also in direct contact with the rod blank, enabling the fisherperson to detect any movement thereof due to a force applied to the tip of the rod blank.

6. The fishing rod assembly as set forth in claim 1, further comprising an insert fitted onto the rearmost end of said rod blank, an outer diameter of said insert and an inner diameter of said base part bore being substantially the same.

7. The fishing rod assembly as set forth in claim 6, wherein said insert is generally cylindrical and has an inner bore drilled out to have a diameter substantially the same as the outer diameter of the rod blank.

8. An improvement to a fishing rod assembly having a rod blank, a handle, and a reel with fishing line, the improvement comprising:
a handle having a base part and reel seat part extending forwardly from the base part, a rearmost end of the rod blank being mounted in a longitudinally extending bore in the base part, the reel seat part having a flat reel seat surface against which the reel is mounted, said rod blank being supported only at said rearmost end by said base part so that the rod blank is free-floating to provide increased sensitivity to forces applied to a tip of the rod blank via the fishing line.

9. The improvement as set forth in claim 8, wherein said rod blank is exposed from the tip to a forward face of the handle base part to allow a fisherperson's hand to be on the handle and also in direct contact with the rod blank, enabling the fisherperson to detect any movement thereof due to a force applied to the tip of the rod blank.

10. The improvement as set forth in claim 8, wherein the reel seat part has a top side with a concave upper surface, said rod blank being spaced away from said concave upper surface so that said rod blank is not encumbered by a weight of the reel mounted on the reel seat surface.

11. The improvement as set forth in claim 10, wherein the reel seat surface is on the bottom side of the reel seat part.

12. The improvement as set forth in claim 10, wherein a curvature of said concave upper surface is generally semi-cylindrical.

13. The improvement as set forth in claim 12, wherein a radius of said generally cylindrical upper surface is at least about 1.5 times a radius of said rod blank.

14. The improvement as set forth in claim 8, further comprising an insert fitted onto the rearmost end of said rod blank, an outer diameter of said insert and an inner diameter of said base part bore being substantially the same.

15. The improvement as set forth in claim 14, wherein said insert is generally cylindrical and has an inner bore drilled out to have a diameter substantially the same as the outer diameter of the rod blank.

16. A fishing rod assembly comprising:
an elongated rod blank having a proximal end and a distal tip;
a handle coupled to said rod blank proximal end, said handle including a base part and a reel seat part positioned distal to said base part, said reel seat part extending forwardly from the base part and including a flat reel seat surface against which a reel is mounted; and
a rearmost end of the rod blank being mounted in a longitudinally extending bore in the base part and a part of said rod blank distal to and adjacent said rearmost end being spaced from and not in contact with said reel seat part, said rod blank being supported only at said rearmost end by said base part to be free-floating and more sensitive to forces applied to a tip of the rod blank.

17. The fishing rod assembly as set forth in claim 16, wherein a side of said reel seat part facing said rod blank has a concave surface forming a trough, said rod blank extending through said trough and being spaced from said concave surface of the reel seat part so that said rod blank is not encumbered by a weight of a reel mounted against the reel seat surface.

18. The fishing rod assembly as set forth in claim 17, wherein a curvature of said concave surface is generally semi-circular.

19. The fishing rod assembly as set forth in claim 18, wherein a radius of said trough is at least about 1.5 times a radius of said rod blank.

20. The fishing rod assembly as set forth in claim 16, wherein said rod blank is exposed from the tip to a forward face of the handle base part to allow a fisherperson's hand to be on the handle and also in direct contact with the rod blank, enabling the fisherperson to detect any movement thereof due to a force applied to the tip of the rod blank.
